(19) United States
(12) Patent Application Publication
(10) Pub. No.: US 2004/0177139 A1
(43) Pub. Date: Sep. 9, 2004

(54) Method and apparatus for computing priorities between conflicting rules for network services

(76) Inventors: Christoph L. Schuba, Sandhausen (DE); Santashil PalChaudhuri, Houston, TX (US); Raphael J. Rom, Palo Alto, CA (US); Michael F. Speer, Mountain View, CA (US)

Correspondence Address: PARK, VAUGHAN & FLEMING LLP, 508 SECOND STREET, SUITE 201, DAVIS, CA, 95616, US

(21) Appl. No.: 10/379,031

(22) Filed: Mar. 3, 2003

(51) Int. Cl. G06F 15/173

(52) U.S. Cl. 709/223

(57) ABSTRACT

One embodiment of the present invention provides a system that resolves conflicts between rules for network services. During operation, the system receives a set of network service rules for network data traffic from multiple network services, wherein network service rules from different network services can possibly conflict. Next, the system identifies conflicts between pairs of network service rules in the set of network service rules. The system then determines a priority relationship between each pair of conflicting network service rules, and assigns priorities to the network service rules in a manner consistent with the determined priority relationships. This allows conflicts between network service rules to be subsequently resolved based on the assigned priorities.

### RELATED APPLICATION

The subject matter of this application is related to the subject matter in a co-pending non-provisional application by inventors Robert D. Bressler, Christoph L. Schuba and Michael F. Speer, entitled, “Method and Apparatus for Managing Packet Flows for Multiple Network Services,” having Ser. No. 10/329,016, and filing date 23 Dec. 2002 (Attorney Docket No. SUN-P9018-SPL).

### BACKGROUND

1. Field of the Invention

The present invention relates to the task of managing packet flows across a computer network. More specifically, the present invention relates to a method and an apparatus that simultaneously manages packet flows for multiple network services.

2. Related Art

Dramatic advances in networking technology presently make it possible to transfer data at bandwidths exceeding 2.5 gigabits per second across a single high-speed optical pipe. These high-speed optical pipes can be used to connect data centers to wide area networks and the Internet. In order to effectively use the bandwidth available through these high-speed optical pipes, edge devices within the data centers must be able to manage the packet flows received through these pipes. For example, an edge device can perform a number of operations related to managing network flows, such as performing firewall functions, service level agreement (SLA) monitoring, transport matching and load balancing. Performing these operations can be an extremely challenging task because the packet flows need to be managed as they are received at high transfer rates.

These operations are typically applied to packet flows in a pipelined fashion. For example, referring to FIG. 1, a packet flow received through high-speed pipe 102 feeds through a pipeline that includes a number of separate modules, including a firewall module 104, an SLA monitoring module 105, a transport matching module 106 and a load-balancing module 107. The output of this pipeline feeds through a switch 108, which switches packets to various servers 110-112 within the data center. This pipelined architecture allows the modules to operate sequentially on the packet flow. However, passing the packet flow through multiple pipeline stages increases latency, which can adversely affect performance for many applications.

Note that each of these pipeline modules can conceptually be divided into three components: (1) a classifier and dispatch component; (2) a module-specific component that directly operates on the packets in the packet flow; and (3) a management and administration component that generates rules for the classifier and dispatch component. (Note that the classifier and dispatch component and the module-specific component are collectively referred to as the “data plane,” whereas the management and administration component is referred to as the “control plane”). In this way, the high-speed classification and dispatch operations performed by the data plane can be separated from the management and administration functions performed by the control plane. FIG. 2 illustrates how the modules in FIG. 1 can be separated into separate control plane and data plane modules.

A standardized interface is being developed to facilitate this separation. In particular, see the paper entitled “Open Standards for the Control and Forwarding Planes in Network Elements,” by Lily L. Yang, Ram Gopal and Susan Hares, which defines a standardized interface between the control and forwarding planes. This standardized interface allows system vendors to use components from different suppliers to perform these control and forwarding functions.

In order to provide additional performance, a number of pipelines can operate in parallel. For example, referring to FIG. 3, the packet flow from high-speed pipe 102 is routed into three parallel pipelines by fan out module 300. The outputs of these pipelines feed into switch 108, which switches packets from the pipelines to various servers 110-112 within the data center.

Providing parallel pipelines can improve performance if the packet stream can be divided into separate flows for the different pipelines. However, it does not help if the packet stream contains only a single flow. Moreover, this technique does not reduce the number of pipeline stages, and consequently does little to reduce latency.

In order to solve the above-described problems, it is desirable to collapse the various operations related to managing network flows into a single flow classification and dispatch step. This reduces the latency involved in applying the operations to the packet flow in pipelined fashion as is illustrated in FIGS. 1-3. However, in order to collapse the operations in this way, it is necessary to resolve conflicts between rules for the various network services, such as load balancing and firewall services. (These rules will be subsequently referred to as “network service rules.”).

Fast and scalable packet classification has received broad attention for quite some time. However, filter conflict detection has received attention only recently. In a paper entitled “Detecting and Resolving Packet Filter Conflicts” by Adiseshu Hari, Subhash Suri, and Guru Parulkar, Proceedings of Infocom, March 2000, a technique for detecting a conflict between two k-tuple filters is presented, as well as a fast technique for two-dimensional classifiers. This technique works even for rule graphs with cycles, because it creates a new filter when any conflict occurs instead of prioritizing the filters. Note that this technique is relatively inefficient, because its running time is O(n²) in the number of rules. Also, the total number of rules in their approach increases exponentially with the number of conflicts. This exponential growth is a severe limitation in classifiers that have limited space for rule tables.

Eppstein and Muthukrishnan describe new data structures for detecting rule set conflicts in time complexity O(n^{3/2}) in a paper entitled, “Internet Packet Filter Management and Rectangle Geometry,” by David Eppstein and S. Muthukrishnan, 12th ACM-SIAM Symposium on Discrete Algorithms (SODA), January 2001. However, this technique, which is based on rectangle geometry, works only for the two-dimensional case. It also assigns different priorities to rules to resolve conflicts.

Florin, Baboescu and Varghese describe a different approach in a paper entitled, “Fast and Scalable Conflict Detection for Packet Classifiers,” International Conference on Network Protocols (ICNP), November 2002. They suggest building tries for each filter field, wherein each level of the trie is one bit of the field. A bit vector from this trie is computed to aid in conflict detection. For a database of 20,000 rules, this technique was measured to execute up to 40 times faster than the naive implementation (O(n²)). However, the paper contains no improvement in computational complexity over O(n²).

Hence, what is needed is a method and an apparatus that resolve conflicts between rules for network services without the inefficiencies described above.

### SUMMARY

One embodiment of the present invention provides a system that resolves conflicts between rules for network services. During operation, the system receives a set of network service rules from multiple network services, wherein network service rules from different network services can possibly conflict. Next, the system identifies conflicts between pairs of network service rules. The system then determines a priority relationship between each pair of conflicting network service rules, and assigns priorities to the network service rules in a manner consistent with the determined priority relationships. This allows conflicts between network service rules to be subsequently resolved based on the assigned priorities.

In a variation on this embodiment, the system processes an additional network service rule in an on-line manner. This involves receiving the additional network service rule at run time, and then identifying any conflicts that may exist between the additional network service rule and existing rules in the set of network service rules. It also involves determining a priority relationship between the additional network service rule and any conflicting network service rules that may exist. The system then assigns a priority to the additional network service rule, and reassigns priorities, if necessary, to existing network service rules.

In a variation on this embodiment, assigning the priorities to the network service rules involves a number of operations. First, the system creates a vertex in a graph for each network service rule in the set of network service rules. The system also inserts a directed edge into the graph between vertices associated with each pair of conflicting network service rules. Each directed edge points from a vertex associated with a lower priority network service rule to a vertex associated with a higher priority network service rule in accordance with the determined priority relationship between the pair of conflicting network service rules. Next, the system performs a topological sort on the graph. The system subsequently assigns priorities to network service rules. This involves traversing vertices of the graph in sorted order, and assigning priorities to network service rules associated with the vertices in a manner consistent with the determined priority relationships.

In a variation on this embodiment, assigning priorities to network service rules involves: assigning a priority of one to a network service rule, if the network service rule is associated with a vertex that has no directed edges pointing to other vertices. On the other hand, if a network service rule is associated with a vertex that has one or more directed edges pointing to other vertices, the system determines a maximum priority for network service rules associated with the other vertices, and assigns a priority of one plus the maximum priority to the network service rule.

In a variation on this embodiment, the system installs a set of low-level flow rules produced from the prioritized network service rules into a flow enforcement device. This flow enforcement device applies the set of flow rules to a packet flow received from a high-speed network connection.

In a variation on this embodiment, determining if a pair of network service rules conflicts involves determining relationships between corresponding filter-fields in the pair of network service rules. If all of the filter-fields are disjoint, the system determines that the given pair of network service rules does not conflict. On the other hand, if at least one of the filter-field relationships is not disjoint, the system determines that the pair of network service rules does conflict. In this case, the system also determines a conflict relationship between the pair of conflicting network service rules by combining the filter-field relationships.

In a variation on this embodiment, determining a priority relationship between a given pair of conflicting network service rules involves considering a priority policy as well as the conflict relationship between the pair of conflicting network service rules.

In a variation on this embodiment, each of the network service rules specifies a filter that defines a class of packets in the packet flow, and an action that defines an operation to be applied to the class of packets.

In a variation on this embodiment, an operation defined by a network service rule can include, but is not limited to: dropping a packet, gathering statistical information about the packet, controlling timer functions associated with the packet, modifying the packet, and passing the packet on.

In a variation on this embodiment, wherein the multiple network services can include, but is not limited to: a firewall service, a service level agreement monitoring service, a load balancing service, a transport matching service, a failover service, and a high availability service.

### BRIEF DESCRIPTION OF THE FIGURES

FIG. 1 illustrates a pipeline containing network service modules.

FIG. 2 illustrates a pipeline containing network service modules with separate components for management and classification/dispatch in accordance with an embodiment of the present invention.

FIG. 3 illustrates a set of parallel pipelines containing network service modules.

FIG. 4 illustrates an architecture that handles packet flows in accordance with an embodiment of the present invention.

FIG. 5 presents a more-detailed view of the flow manager architecture illustrated in FIG. 4 in accordance with an embodiment of the present invention.

FIG. 6 presents a flow chart illustrating the operation of the flow manager in accordance with an embodiment of the present invention.

FIG. 7 presents a flow chart illustrating how a new flow is handled in accordance with an embodiment of the present invention.

FIG. 8 presents a flow chart illustrating how environment information is used to update flow rules in accordance with an embodiment of the present invention.

FIG. 9A presents a flow chart illustrating how information from an application is used to update flow rules in accordance with an embodiment of the present invention.

FIG. 9B presents a flow chart illustrating how information from an administrator is used to update flow rules in accordance with an embodiment of the present invention.

FIG. 10 presents a flow chart illustrating how conflicts between network service rules are detected and resolved in accordance with an embodiment of the present invention.

FIG. 11 presents a flow chart illustrating how priorities are assigned to network service rules in accordance with an embodiment of the present invention.

FIG. 12 illustrates how relationships are determined between filter-fields in accordance with an embodiment of the present invention.

FIG. 13A presents a conflict relationship table in accordance with an embodiment of the present invention.

FIG. 13B presents another conflict relationship table in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Flow Manager Architecture

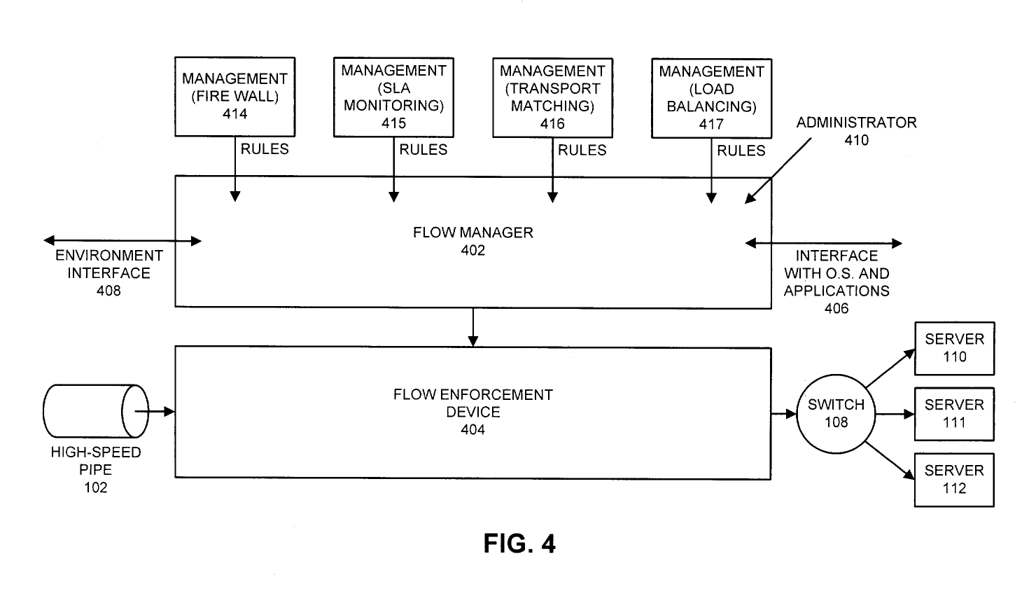

FIG. 4 illustrates an architecture that handles packet flows in accordance with an embodiment of the present invention. This architecture includes flow manger 402 and flow enforcement device 404. During operation, flow enforcement device 404 receives packets from high-speed pipe 102 and routes the packets to through switch 108 to servers 110-112. Flow enforcement device 404 can also perform simple operations on the packets, such as translating packet headers.

Flow manager 402 generates a consistent set of rules for flow enforcement device 404 based on rules received from various components. For example, FIG. 4 illustrates an exemplary set of components, including firewall management component 414, SLA monitoring component 415, transport matching management component 416 and load balancing management component 417. Note that this exemplary set of components is provided for purposes of illustration only. In general, the system can include many other different types of components. Also note that rules from different components can potentially conflict.

Firewall management component 414 provides various security features associated with firewall functions performed by the edge device. For example, firewall management component 414 can implement an access control policy that only allows specific packets to reach servers 110-112.

SLA monitoring component 415 provides various services associated with monitoring service level agreements for customers that make use of servers 110-112.

Transport matching management component 416 matches a network flow with an underlying transport protocol. Note that communications coming into a data center are typically TCP/IP traffic. Furthermore, the source of a communication assumes that the destination is speaking the same protocol. However, a data center may choose to use a different protocol within its own walls for reasons of efficiency or backward compatibility. For example, some companies are presently talking about using Infiniband (IB) within a server cluster. For this to work, some mechanism has to terminate the TCP flow and initiate an IB flow within the cluster. This process is known as “transport matching.”

Load balancing management component 417 routes packets to servers 110-112 in a manner that balances load between servers 110-112. For example, if one server is heavily loaded, load balancing management component 417 can route a new flow to a less loaded server.

Flow manager 402 can also receive input from other sources. (1) Flow manager 402 can receive commands from an administrator specifying, for example, how to route specific flows and how to prioritize network services. (2) Flow manager 402 can receive input from an environment interface 408 that communicates with environment agents. (3) Flow manager can also receive input from another interface 406 that communicates with an operating system and applications running on servers 110-112.

Flow manager 402 considers these inputs and rules in creating a single consistent set of flow rules in a low-level form that can be used by flow enforcement device 404. In one embodiment of the present invention, each of the low-level flow rules specifies a filter that defines a class of packets in the packet flow as well as an action that defines an operation to be applied to the class of packets. In this way, the filter can be used to identify packets that the flow rule applies to, and the action can be used to apply the operation to the identified packets.

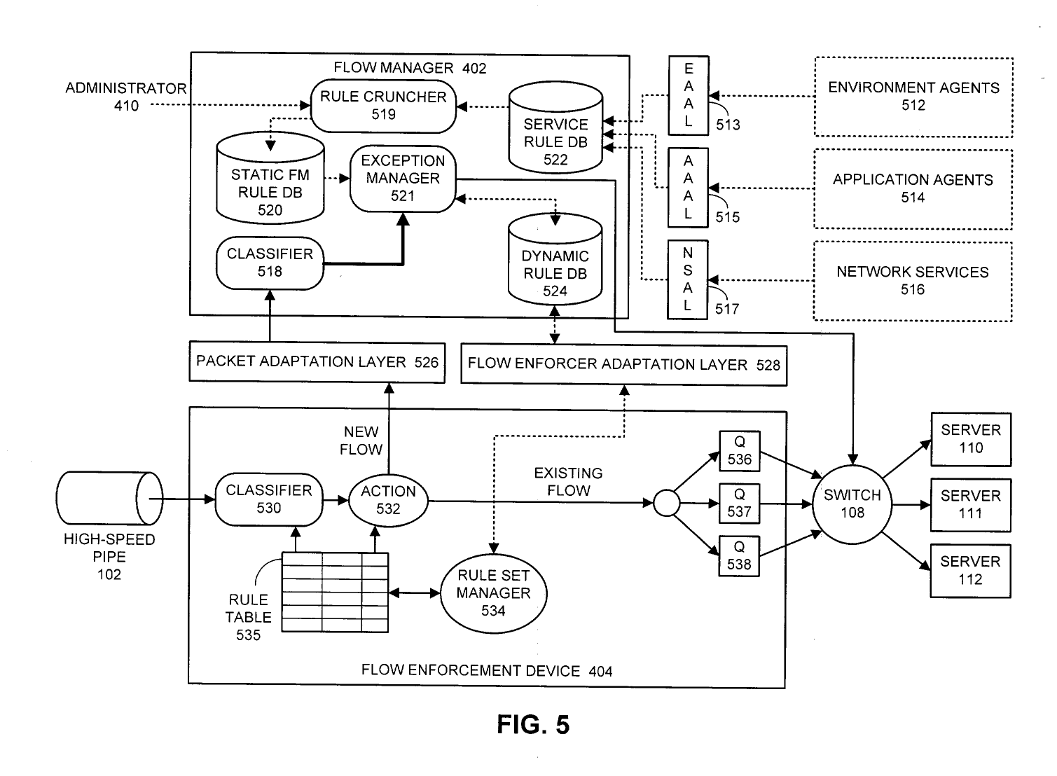

FIG. 5 presents a more-detailed view of the flow manager architecture illustrated in FIG. 4 in accordance with an embodiment of the present invention. In FIG. 5, flow manager 402 receives inputs from environment agents 512 through environment agent adaptation layer (EAL) 513. Environment agents 512 can for example provide information on the time of day, which allows rules to change depending upon the time of day. Environment agents 512 can also provide information on current network traffic, which may, for example, indicate that a denial of service attack is taking place.

Flow manager 402 also receives input from application agents 514 through application agent adaptation layer (AAL) 515. Application agents 514 can provide information from an operating system or application running on servers 110-112. For example, an application can indicate that a customer has provided a credit card number to a web site, thereby indicating that the customer is a paying client, as opposed to someone who is merely browsing through the web site. This may cause flow manager 402 to give network flows from the customer a better level of service.

Flow manager 402 also receives rules from various network services 516 through network service adaptation layer 517. As in FIG. 4, these network services can include management component 414, SLA monitoring component 415, transport matching management component 416 and load balancing management component 417.

Flow manager 402 uses inputs received from environment agents 512, application agents 514 and network services 516 to create and/or modify rules in service rule database 522.

Rule cruncher 519 combines rules from service rule database 522 and input from administrator 410 to produce rules that are stored in static flow manager (FM) rule database 520. These rules are subsequently fed through exception manager 521, which generates rules for new flows. The resulting rules are stored in dynamic rule database 524.

Flow enforcement device 404 includes rule set manager 534, which retrieves rules through flow enforcement adaptation layer 528 and uses the rules to populate rule table 535. Flow enforcement device 404 also includes classifier 530, which uses filters from rule table 535 to identify packets associated with specific rules.

Once packets are identified, specified actions are applied to the packets by action module 532. In doing so, action module 532 feeds flows into a number of queues 536-537, which feed into switch 108. Action module 532 can perform a number of actions on packets, such as, dropping packets, translating headers of packets, and inserting metadata into packets.

If action module 532 encounters a packet that does not match any of the existing filters, the packet is part of a new flow. Information associated with the packet feeds through packet adaptation layer 526 into classifier 518 within flow manager 402. The default behavior is to forward to packet to exception manager 521, which generates rules for the new flow. These rules are stored in dynamic rule database 524 and are used to populate rule table 535 within flow enforcement device 404.

Operation of Flow Manager

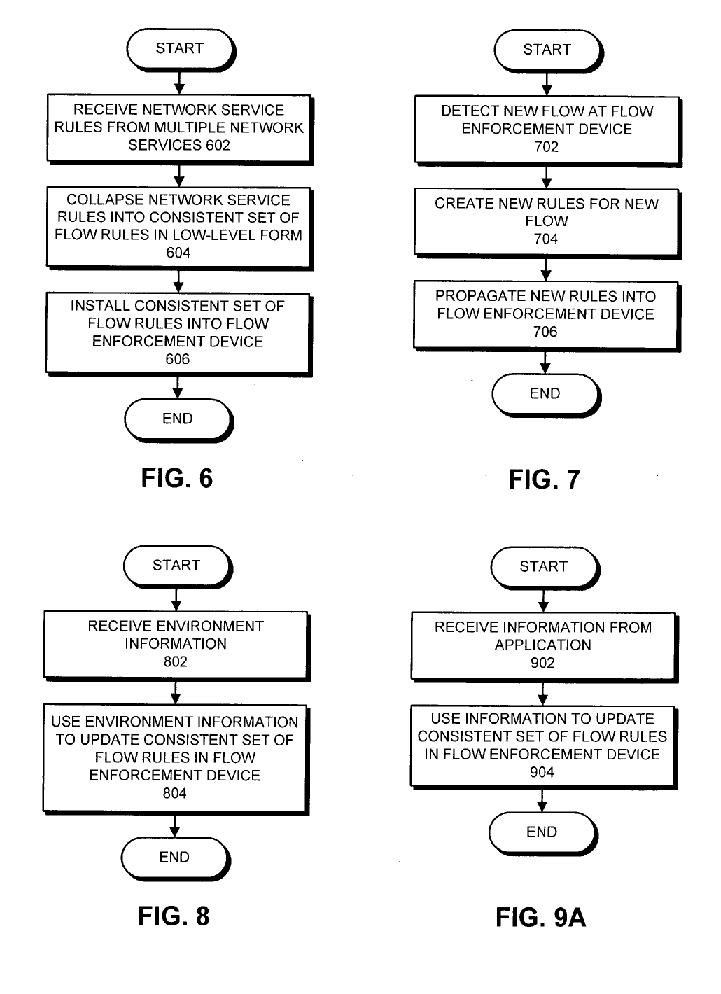

FIG. 6 presents a flow chart illustrating the operation of flow manager 402 in accordance with an embodiment of the present invention. Upon receiving rules from multiple network services (step 602) (as well as input from environment agents 512, application agents 514 and administrator 410), rule cruncher 519 collapses the rules into a consistent set of flow rules in a low-level form suitable for use by flow enforcement device 404 (step 604).

In one embodiment of the present invention, the task of collapsing the rules involves identifying conflicts between rules and assigning different priorities to the conflicting rules. This allows higher priority rules to be applied before lower priority rules. For example, firewall rules can be given a higher priority than load balancing rules, because the firewall rules ensure security of the datacenter, whereas the load balancing rules merely improve server utilization.

The resulting rules are stored into rule table 535 within flow enforcement device 404 (step 606), and are subsequently used in processing packets received through high-bandwidth pipe 102.

New Flow

FIG. 7 presents a flow chart illustrating how a new flow is handled in accordance with an embodiment of the present invention. The process starts when a new flow is detected at flow enforcement device 404 (step 702). This detection can occur, for example, when a received packet does not match any existing templates in rule table 535. This new flow is communicated to classifier 518 within flow manager 402. The output of classifier 518 is used by exception manager 521 to produce new rules for the new flow (step 704). These new rules are then integrated into the consistent set of rules stored in dynamic rule database 524, which allows them to be propagated into rule table 525 within flow enforcement device 404 (step 706).

Updating Flow Rules

FIG. 8 presents a flow chart illustrating how environment information is used to update flow rules in accordance with an embodiment of the present invention. Upon receiving environment information from environment agents 512 (step 802), the system uses the environment information to update the flow rules in rule table 535 within flow enforcement device 404 (step 804). This involves updating rules in service rule database 522, static flow manager rule database 520 and dynamic rule database 524 as is described above with reference to FIG. 5.

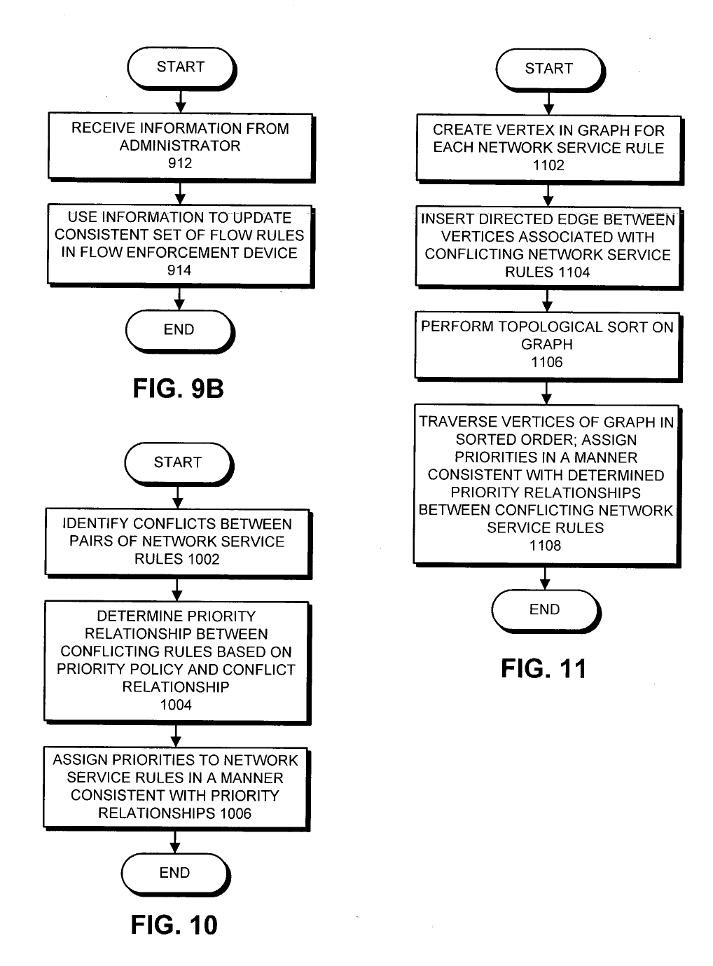

FIG. 9A presents a flow chart illustrating how information from an application is used to update flow rules in accordance with an embodiment of the present invention. Upon receiving new information from an application or operating system from application agents 514 (step 902), the system uses the information to update the flow rules in rule table 535 within flow enforcement device 404 (step 904). As above, this involves updating rules in service rule database 522, static flow manager rule database 520 and dynamic rule database 524.

FIG. 9B presents a flow chart illustrating how information from an administrator is used to update flow rules in accordance with an embodiment of the present invention. Upon receiving new information from an administrator 410 (step 912), the system uses the information to update the flow rules in rule table 535 within flow enforcement device 404 (step 914). This involves updating static flow manager rule database 520 and dynamic rule database 524.

Rule Cruncher

Recall from the discussion above that rules comprise filters and actions. Filters are patterns identifying packets sharing the same actions. A filter conflict occurs when two or more filters identify the same set of packets but with different actions, creating ambiguity in packet classification. To resolve the ambiguity one needs to determine which action should be performed and in what order.

We describe an offline and an online version of a technique that collapses large sets of conflicting network service rules into a consistent set of low-level flow rules to be enforced efficiently by network processors. The techniques, called the “offline rule cruncher” and the “online rule cruncher,” determine if rules are to be applied to multiple traffic flows, and if so, resolve such conflicts by assigning policy-based priorities.

The online version determines new policy-based priorities for each new rule that is added to an existing rule database, while the offline version assigns priorities in one sweep after the all the rules have been created.

Both techniques assign the smallest possible range of priority values to the rule set in question. The complexity of the offline rule cruncher technique is O(n²) in the number of rules n, while the complexity of the online rule cruncher technique is O(n+m) in the number of rules n and number of conflicts m, however, the expected performance is much better, namely O(n), if the assumption that conflicts in rule sets are rather rare holds true.

As input, the rule cruncher accepts, rules from external entities (such as firewall, load-balancing, fail over, and service level agreement monitoring) or application agents, and policies, such as priorities between network service rules or actions. The purpose of the rule cruncher is to create a set of low-level rules that can be enforced by high performance network processors that operate in the FED on the data path. To accomplish that, the rule cruncher determines if rules are conflicting, i.e., if they are to be applied to multiple traffic flows. If this is the case, the technique assigns a policy-based priority in which the conflicting rules must be applied to correctly enforce the high-level rule set.

Terminology and Definitions

Different network services act on incoming packets and perform various actions. In one embodiment of the present invention, network services communicate to the flow manager which actions the flow enforcement device is supposed to perform on which packet. This communication is in the form of rules. To be precise and to facilitate the understanding of the technique description later, we first describe our terminology in more detail.

Rules, Filters, and Actions

A Rule is composed of a Filter and an Action, where the Filter defines a class of packets on which an operation defined by Action is to be performed. We denote that as,

Rule :=<Filter, Action>.

Typical Actions are, for example, dropping a packet, gathering statistical information, controlling timer functions, modifying (also known as “marking”) a packet with meta-data (e.g., inserting new fields or overwriting existing fields), or passing the packet on (i.e., doing nothing).

Actions := Insert | Overwrite | Delete |

Gather statistics | Control timer functions |
Checksum calculation | Hash calculation |
Drop | Output | Update rule | Message host |

Pass

A Filter is a mechanism to define a class of packets. It is composed of Protocol Filters each of which is composed of Field Filters.

Filter:=<Protocol-Name, Protocol-Filter>+

Protocol Names are taken from a list of literals, whichever are supported, e.g., MAC, IPv4, MPLS, TCP, etc.

Each Protocol Filter identifies patterns for various fields that data packets are matched against. Each Protocol Filter is therefore composed of several Field Filters.

Protocol-Filter := <Field-Filter>⁺
Field-Filter := <Field-Name, Selector>

Each Field-Filter contains a Field Name and a Selector. The Field Name identifies (in a one-to-one correspondence) the possibly masked, header field in a Protocol Layer. For example, in the IP (Network) layer a field name can be IP source address, the last 4 bits of the IP destination address, etc. Each selector is composed of a tuple <Value, Operation> which together determine how to test a packet field for a match.

Selector :=<Value, Operation>

Value, is a numerical or bit-string value, and Operation is one of {NOOP, EQ, NEQ, GT, LT} corresponding to no-operation, equality, inequality, greater-than, less-than.

Operation := NOOP | EQ | NEQ | GT | LT
Value := numerical-value | bitstring

Matching

Given p field value, the value of a specific field in a data packet p, we say that the field is matched, if the following boolean expression evaluates to TRUE for the appropriate field.

p.field.value Selector.Operation Selector.Value

We say that a “packet matches a filter” if all its fields are matched by the filter. We say a “packet matches a rule,” if it matches the rule's filter.

For example, the Field <IP-source-address, <128.12.30.151, NEQ>> matches all packets p whose IP source address is different from 128.12.30.151. The NOOP operator always yields TRUE, i.e., matches all values (and is customarily denoted by *).

Rule Conflicts and Relationships

In one embodiment of the present invention, there are many rules concurrently present and active in the Flow Manager. Because these rules stem from various applications (or even similar applications on different hosts) a packet could be the subject of actions of more than a single rule. We call this occurrence a “rule conflict.”

We express how rules conflict in the following way. Given two rules r and r′, we can define two sets S and S′ of packets. Set S (S′) contains exactly those packets that match rule r (r′). We can now consider the set relationship between S and S′. They can either be disjoint (DISJOINT), identical (EQUAL), they can intersect (INTERSECT), S can contain S′ (SUPERSET), or S can be contained by S′ (SUBSET).

We use these same terms to describe the relationship between rules r and r′, or more detailed between two protocol-filters or two field-filters. So, for example, if no possible packet can match both rules r and r′, then the relationship between r and r′ is DISJOINT. If rule r is identical to rule r′ but specifies one additional field filter that was not specified for rule r′, then r is more specific than r′ and the relationship between r and r′ is SUBSET.

Problem Statement and Contribution

Depending on the type of actions specified, all or just a subset of these actions may need to be performed on the same packet. The Flow Manager needs a mechanism to correctly and efficiently sort these out such that packets that match multiple rules are acted upon in the correct order. To that end, the Flow Manager assigns a priority to every rule and maintains these rules in a conceptual database which we term RuleDB. In other words, RuleDB is a rule set that consists of tuples (r,p) where r is a rule and p is the assigned priority. We present a technique that first detects if rules conflict, and for conflicting rules, assigns different priorities to the rules. The priorities determine the order in which actions are to be performed. By convention, if a packet matches multiple rules, rules with higher priority values are applied before rules with lower priority values.

Rule Cruncher Techniques

The goal of the rule cruncher techniques is to take inputs (rules) from multiple sources and to generate a consistent rule database that is conflict free and consumable by Flow Enforcement Devices (FEDs). “Conflict-free” means that the priority values of every two conflicting rules clearly identify which rule has higher priority. “Consumable by Flow Enforcement Devices” means that priorities are encoded as non-negative integer values, a real-world constraint this technique is designed to satisfy.

For practical reasons, FED implementations must limit the maximum value for priorities, so our techniques assign the smallest possible integer values to keep the range of integer priority values as small as possible. Although our technique assigns priority values from the domain of non-negative integer numbers (because that is what typical FEDs expect), other conventions could be used, e.g., positive real numbers.

We present two techniques: offline and online. The offline technique starts with an empty RuleDB and is useful when a system is being initialized, i.e., when a (large) set of known rules needs to be combined into a single RuleDB. The online version is useful when a single rule needs to be entered into an existing (nonempty) RuleDB.

From now on we view the RuleDB as a directed a cyclic graph (DAG) G=(V,E) of vertices V and edges E.

Each vertex represents a tuple (rule,priority). An unassigned priority is denoted by 0, e.g., (r, 0). Edges represent a resolved conflict relationship between vertices. For example, edge (v,v) in E says that the rule r represented by vertex v has a priority dependency on the rule r′ represented by vertex v′. Rule r has a lower priority than rule r′.

The Offline Rule Cruncher Technique

The offline rule cruncher technique operates on two input parameters:

R: a set of rules; and

PP: a policy that encodes how rule conflicts are resolved.

The technique's output is

G: a DAG that includes all rules in R (as vertices) as well as their newly assigned priority values.

High-Level Description of the Offline Rule Cruncher Technique

The offline version of the technique starts with an empty DAG G, adding vertices v to V, until there are no more rules to add. Rule conflicts are resolved every time v is inserted into V. They are recorded as a dependency (i.e., new edges in E.)

Next, the DAG G is topologically sorted into a list L. Finally, this list L is traversed once and minimal positive integer value priorities are assigned in every rule vertex to finish building a single, conflict-free RuleDB.

Pseudo Code for Offline Rule Cruncher Technique

The following pseudo-code of the technique calls three functions, ConflictDetector( ), ConflictResolver( ), and TopologicalSort( ). A few words about them first.

The Function ConflictDetector( ) is explained in detail below. It determines if there is a conflict between any two rules. It expresses the conflict in terms of their relationship. If the result is DISJOINT, then the rules do not conflict, all other return values indicate a conflict.

The Function ConflictResolver( ) is also explained below. Given that there is a conflict between two rules, it determines which rule has precedence, i.e., which of the two rules has the lower priority and which has the higher priority. The function takes two additional inputs: the previously computed relationship and the priority policy (PP).

The Function TopologicalSort(G) is a standard DAG depth-first graph traversal function. Given a directed, acyclic graph G=(V,E), it creates a linear ordering of all its vertices such that if G contains an edge (u,v), then u appears before v in the ordering.

Technique:

| | |
|---|---|
| G | <− OfflineRuleCruncher(R,PP) |

| | |
|---|---|
| 1 | initialize G = (V,E) to empty; |
| 2 | FOR each rule r in R DO |

| | |
|---|---|
| 3 | create vertex v <− (r,0); |
| 4 | add v to V; |
| 5 | FOR each vertex v′ in V \ {v} DO |

| | |
|---|---|
| 6 | rel <− ConflictDetector(v,v′); |
| 7 | IF (rel != DISJOINT) |
| 8 | THEN add to E: (vl,vh) <− |

ConflictResolver (v,v′,rel,PP);

| | |
|---|---|
| 9 | L <− TopologicalSort(G); |
| 10 | FOR each v in L (traversal in order) DO |

| | |
|---|---|
| 11 | IF (there is no (v′,v) in E) |

| | |
|---|---|
| 12 | THEN v.prio <− 1; |
| 13 | ELSE v.prio <− 1 + max{v′.prio : (v′,v) \in E}; |

| | |
|---|---|
| 14 | RETURN (G); |

The technique is explained as follows. Line 1 initializes the RuleDB to empty.

Lines 2-8 are the main loop that takes every supplied rule in R and adds it to the RuleDB, resolving possible conflicts. Lines 3 and 4 create the new vertex for the rule, initialize its priority to a default unassigned value and insert it into the set of graph vertices V. Lines 5-8 compare the rule that is being inserted into the RuleDB with every other rule that is already in RuleDB in order to determine if there exists a conflict (call to function ConflictDetector( )). If a conflict is detected (i.e., their relationship is not DISJOINT), a new edge is created and inserted into the set of edges E. It represents the conflict's resolution. The vertices for the new edge are determined by a call to function ConflictResolvero( ).

Line 9 is a call to the TopologicalSort function on the RuleDB. Its output is a topologically sorted list L.

Lines 10-13 traverse this list L in order and assign minimal integer values to the priority values in each vertex. If a vertex has no incident edges (line 12), value 1 is assigned (the smallest non-negative integer). Otherwise, line 13 determines the largest priority of all vertices that are directly connected to incident edges, increments it by 1 and assigns it.

Different vertices in G can have the same priority values assigned, which implies their rules are not conflicting and thus there is no priority relationship between them.

Online Rule Cruncher Technique

The online rule cruncher technique operates on three input parameters:

r: a rule to be inserted into G

G: a DAG that consists of existing rules including their assigned priorities.

PP: a policy that encodes how rule conflicts are resolved.

The technique's output is

G: a modified version of the input DAG G, augmented by a vertex (r,p), possibly new edges that represent the dependencies between r and other rules in G, and some updated priorities.

High-Level Description of the Online Rule Cruncher Technique

We expect, in general, that conflicts in the rule set are rather rare. This expectation implies the graph G is rather sparsely connected with edges. In fact, the graph can rather be seen as a collection of many disconnected components (subgraphs). There are no conflicts between rules of nodes that belong to different subgraphs. Note that it is indeed possible that all vertices in G are connected. Our technique works in all these cases, but obviously it will operate faster on a smaller subgraph than the entire graph.

The online version of the technique starts with a preexisting DAG G. Vertex v for rule r is inserted by examining all rules r′ in G to detect conflicts with the new rule. Conflicts are recorded as new edges in E (i.e., as priority dependencies.)

From now on we only need to consider the subgraph G′ of G that contains the new vertex v. We sort G′ topologically into list L. We then traverse the list L once and assign minimal positive integer value priorities.

Pseudo-Code for Online Rule Cruncher Technique

| | |
|---|---|
| G | <− OnlineRuleCruncher (r,G,PP) |

| | |
|---|---|
| 1 | create vertex v <− (r,0); |
| 2 | add v to V; |
| 3 | FOR each vertex v′ in V \ {v} DO |

| | |
|---|---|
| 4 | rel <− ConflictDetector(v,v′); |
| 5 | IF (rel != DISJOINT) |

| | |
|---|---|
| 6 | THEN add to E: (vl,vh) |

<− ConflictResolver (v,v′,rel,PP);

| | |
|---|---|
| 7 | Let G′=(E′,V′) be the subgraph of G that |

contains v;

| | |
|---|---|
| 8 | L <− TopologicalSort(G′) |
| 9 | FOR each v in L (traversal in order) DO |

| | |
|---|---|
| 10 | IF (there is no (v′,v) in E′) |

| 11 | THEN v.prio <− 1; |
|---|---|
| 12 | ELSE v.prio <− 1+max{v′.prio : (v′,v) |
| | \in E′}; |

| | |
|---|---|
| 13 | RETURN (G); |

The technique can be explained as follows. Lines 1 and 2 create a vertex v for the new rule r and insert it into the set of graph vertices V.

Lines 3-6 compare the rule that is being inserted into the RuleDB with every other rule that is already in RuleDB in order to determine if there exists a conflict (call to function ConflictResolver( )). If a conflict is detected, a new edge is created and inserted into the set of edges E. The new edge is the result of the computation in ConflictResolver( ) which represents the conflict's resolution.

Line 7 says that from now on the technique operates only on a subgraph of G, namely the connected subgraph of G containing v. As we said earlier, since we expect G to be very sparse, there is a high likelihood that G′ has significantly fewer vertices than G.

Line 8 is a call to the TopologicalSort function on the subset of the RuleDB. Its output is a topologically sorted list L.

Lines 9-12 traverse this list L in order and assign minimal integer values to the priority values in each vertex. If a vertex has no incident edges (line 11), value 1 is assigned (the smallest non-negative integer). Otherwise, line 12 determines the largest priority of all vertices that are directly connected to incident edges, increments it by 1 and assigns the result.

Conflict Detector Technique

The ConflictDetector technique determines if there is a conflict between any two rules. It expresses the conflict in terms of the relationship between the rules. If the result is DISJOINT, then the rules do not conflict, all other possible return values (EQUAL, SUPERSET, SUBSET, INTERSECT) indicate a possible conflict.

To identify by its name a specific filter-field in a rule, given its vertex v in the graph G, one would follow the hierarchy imposed by the grammar defined in a section above, e.g., v.rule.protocol-name.field-name. For the techniques described below, the additional protocol-layer does not play a role. Therefore, for simplicity sake, we will abbreviate references to v.rule.protocol-name.field-name by using v.rule.field.

Input/Output Parameters

The conflict detector technique operates on two input parameters:

v,v′: two vertices in graph G that represents the RuleDB.

The technique's output is

rel: the relationship between the rules v.rule and v′.rule.

High-Level Description of the Conflict Detector Technique

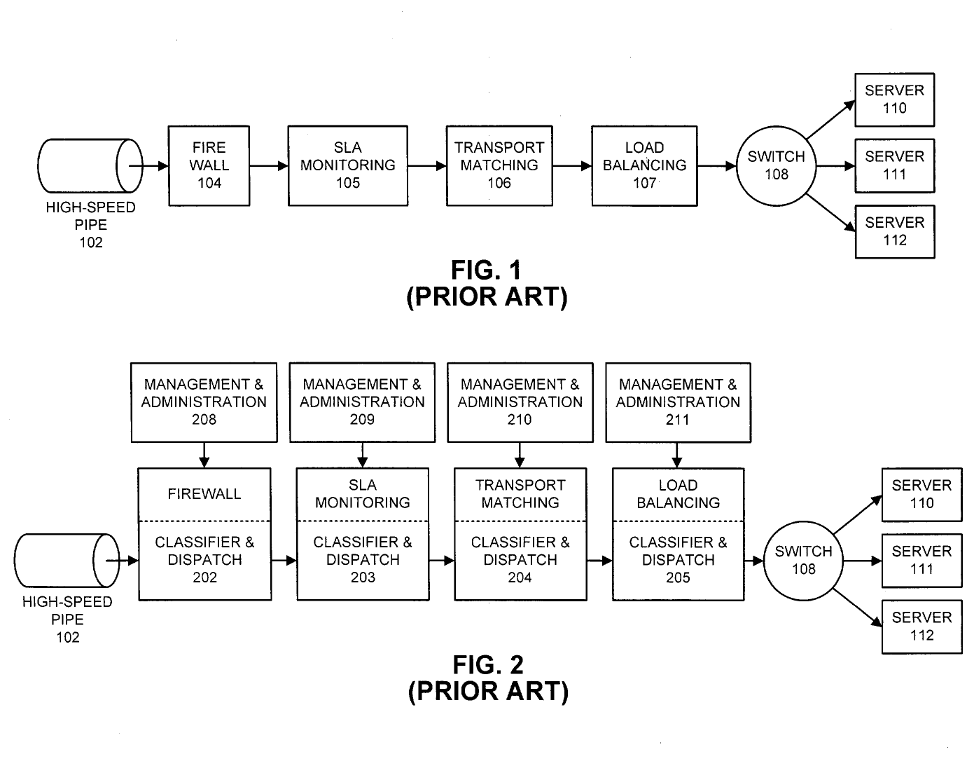

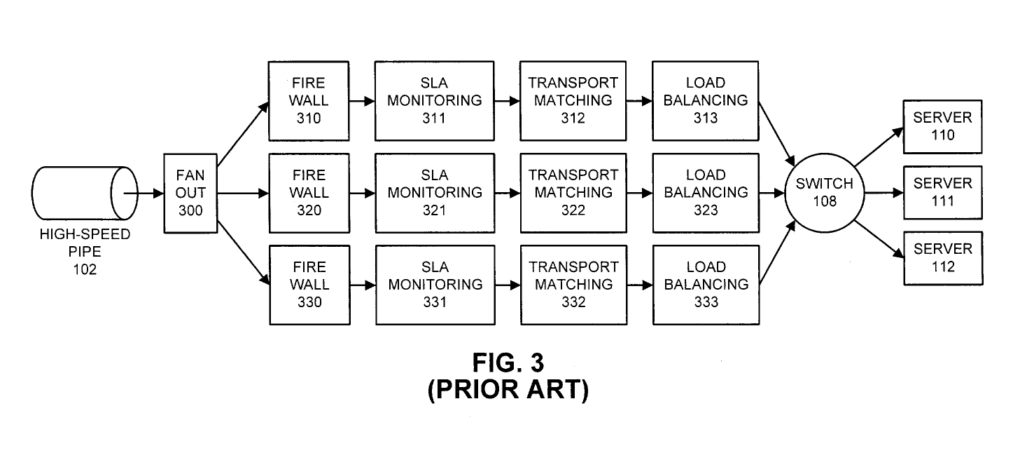

The conflict detector technique compares the corresponding filter fields of two rules with each other. Given two rules, if there exists even one field filter for which the rules are DISJOINT then they do not conflict. Thus, the technique terminates upon the discovery of such a pair with the DISJOINT answer. Function ComputeFieldRelationship( ) which encodes the contents of FIG. 1 above computes the individual field relationships.

While successively computing the field relationships, the technique also maintains the combined relationship of all previously computed field pair relationships.

Once the technique has examined each filter field pair without terminating with a DISJOINT relationship, the technique terminates and returns the calculated combined relationship value.

Pseudo Code for the Conflict Detector Technique

The following technique calls the two functions

| | |
|---|---|
| rel | <− ConflictDetector(v,v′) |

| | |
|---|---|
| 1 | rel <− EQUAL; |
| 2 | FOR all corresponding filter-fields v.rule.f and |

| | v′.rule.f |
|---|---|
| 3 | rel ′<−ComputeFieldRelationship(v.rule.f,v′.rule.f) |
| 4 | IF (rel′) = = DISJOINT |

| | |
|---|---|
| 5 | THEN RETURN (DISJOINT); |

| | |
|---|---|
| 6 | rel=CombineFieldRelationship(rel,rel′); |

| | |
|---|---|
| 7 | RETURN (rel); |

The technique can be explained as follows. Line 1 initializes variable rel to EQUAL. This variable is used to accumulate the results of ComputeFieldRelationship( ). We initialize rel to the zero-element EQUAL, because in accumulating the results, we use the reflexive property as explained in a following section.

Line 2-6 are the main loop in the technique, examining all corresponding filter-fields v.rule.f and v′.rule.f. For each of these pair, we compute their relationship by calling ComputeFieldRelationship (line 3). If their relationship was DISJOINT, the technique terminates, returning DISJOINT (lines 4-5). Otherwise, we accumulate the just calculated result of ComputeFieldRelationship from line 3 with previously accumulated results by calling CombineFieldRelationship( ).

Finally, in line 7, the accumulated relationship is returned.

ComputeFieldRelationship( )

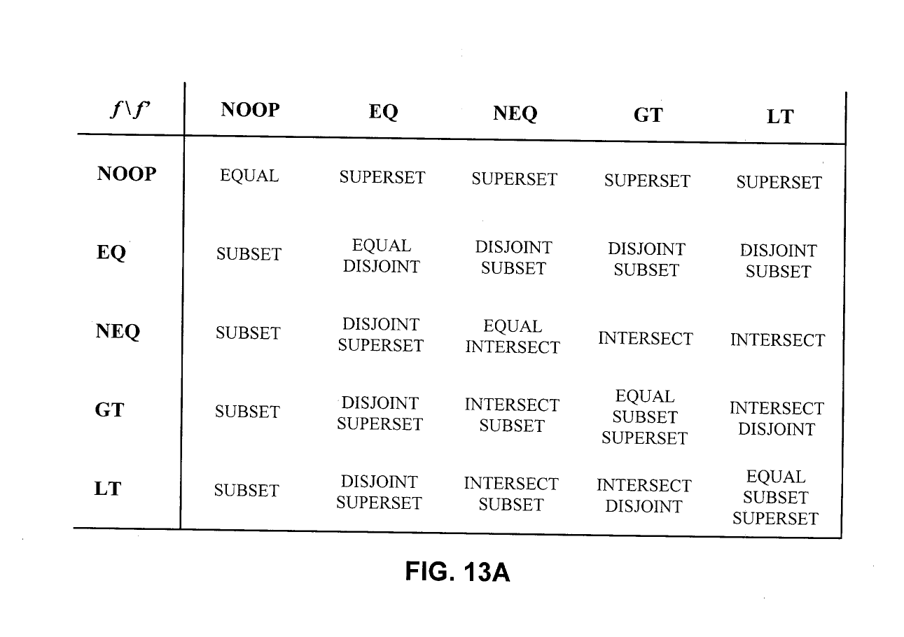

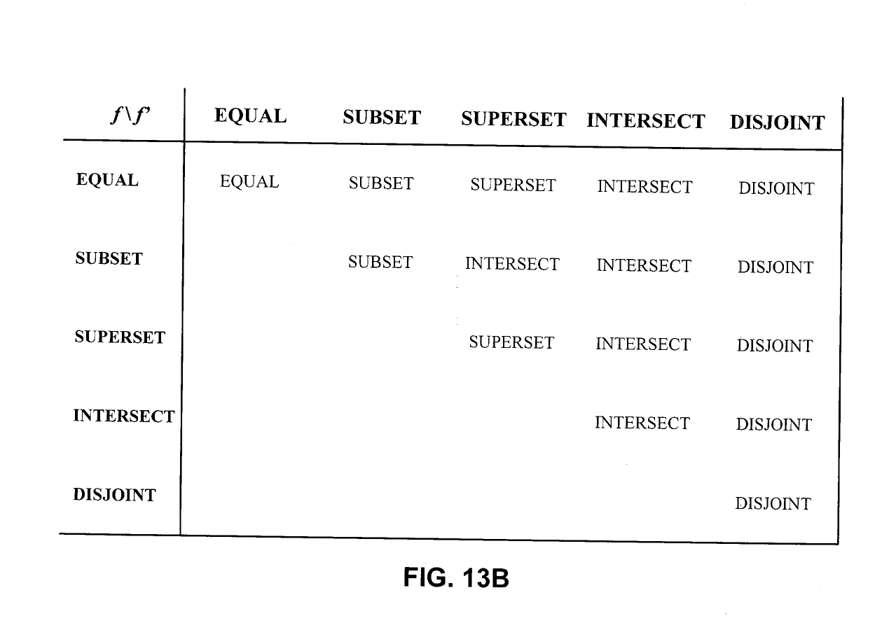

Function ComputeFieldRelationship(ƒ,θ′) operates on the two corresponding field filters of two rules. Their field relationship is constructed in the following fashion. First, one determines the relevant entry in the table depicted in FIG. 13A, by looking up row θ.selector.operation and column θ′.selector.operation. If there is a single entry in the corresponding entry, then the relationship between the two field filters is that particular relationship. If there is more than one entry in a position in the table, then the individual values θ.selector.value and θ.selector.value are included in the computation. A few examples:

(1) NOOP and GT—the relationship is SUPERSET. The field with NOOP encompasses the field with any other option specified.

(2) EQ and EQ—if the value is same in both selectors then the relation is EQUAL, if the values are different then the relation is DISJOINT.

(3) GT and LT—If θ.selector.value is “less than” f′.selector.value then the two field filters INTERSECT. Otherwise, they are DISJOINT.

This function combines two given relationships by looking up one entry in the table in FIG. 13B. In FIG. 13B, column 1 depicts the 5 possible relationships, same as Row 1. The two fields are ANDed in the table. It can be seen that EQUAL is the identity element in the composition. EQUAL AND X=X. It can also be seen that DISJOINT is zero-element. DISJOINT AND X=DISJOINT. As the composition is commutative, the table can be depicted as triangular one.

It is observed that the composition of these relationships are:

REFLEXIVE: X AND X = X
COMMUTATIVE: X AND Y = Y AND X
ASSOCIATIVE: ((X AND Y) AND Z) = (X AND (Y AND Z))

The associativity property is particularly important as we use it extensively in the ConflictDetector technique to accumulate the relationship results.

The Conflict Resolver

Finally, given two conflicting rules, the conflict resolver technique determines which one has precedence, using the priority policy PP that specifies how rule conflicts are resolved.

The priority policy PP encodes the order in which Service Priority, Action Priority, Filter Priority, and Time Priority are applied to determine the final relationship between the rules.

For example, if Service, Action, Filter, Time is the sequence configured—Service Priority would first be used to determine the rule relationship. If it is insufficient (in case both rules belong to the same service or equal priority service), then Action Priority would be used. If that is also insufficient (e.g., if both rules have an equal priority, but different action), then Filter Priority is used. The Filter Priority could be employed in the following way: a relationship of EQUAL could imply the same priority; SUBSET could imply greater, SUPERSET lower priority. If all fails (e.g., in the case of INTERSECT) higher priority could be given to the more recent rule (Time Priority.)

The conflict resolver technique operates on four input parameters:

v, v′: two vertices in graph G that represents the RuleDB.

rel: their relationship, as calculated by ComputeFieldRelationship( )

PP: priority policy for rule conflict resolution

The technique's output is

v_low: the vertex with the rule with the lower priority

v_high: the vertex with the rule with the higher priority

The interface for the Conflict Resolver Technique is

(v_low,v_high)<-ConflictResolver(v,v′,rel,PP)

Its complexity is again constant O(1) in the number of vertices v.

### SUMMARY

We have presented an online and an offline version of a technique that collapses large sets of conflicting network service rules into a consistent set of low-level flow rules to be enforced efficiently by network processors. The techniques, called the “offline” and “online rule cruncher,” determine if rules are to be applied to multiple traffic flows, and if so, resolve such conflicts by assigning policy-based priorities.

The online technique has been implemented and demonstrated on load balancing rules. It determines new policy based priorities for each new rule that is added to an existing rule database, while the offline version assigns priorities in one sweep after the entire rule database has been created.

Both techniques assign the smallest possible range of priority values to the rule set in question. However, using that approach may often completely change the priority assignment to the existing rules in the RuleDB, resulting in large data transfers between the flow manager (FM) and the flow enforcer (FE). In some architectures, it may be advantageous to reduce the amount of communications between the FM and the FE. For such architectures, a better priority assignment is one that spreads the priority values evenly in the allowable range (according to the number of bits in the priority value) so that a single rule insertion is less likely to cause a massive priority reassignment.

Recapping the operations described above, FIG. 10 presents a flow chart illustrating how conflicts between network service rules are detected and resolved in accordance with an embodiment of the present invention. In doing so, FIG. 10 describes in more detail the operations performed in box 604 of FIG. 6. The system first identifies conflicts between pairs of network service rules in the set of network service rules (step 1002). Next, the system determines priority relationships between conflicting rules based on a priority policy and conflict relationships between the conflicting rules (step 1004). Finally, the system assigns priorities to the network service rules in a manner consistent with the determined priority relationships (step 1002).

FIG. 11 presents a flow chart illustrating how priorities are assigned to network service rules in accordance with an embodiment of the present invention. This flow chart describes in more detail the operations performed in box 1006 of FIG. 10. As was described above, the system first creates a vertex in the graph for each network service rule (step 1102). Next, the system inserts directed edges between vertices associated with conflicting rules (step 1104). The directed edges point from lower priority rules to higher priority rules. The system them performs a topological sort on the graph (step 1106). Finally, as was discussed previously, the system traverses the graph in sorted order, and assigns priorities in a manner consistent with the determined priority relationships between the conflicting network service rules (step 1108).

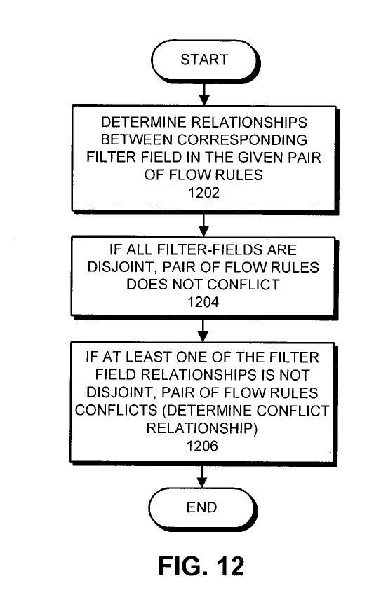

FIG. 12 illustrates how relationships are determined between filter-fields in accordance with an embodiment of the present invention. This flow chart describes the operations involves in determining a conflict relationship between two rules. As was described above, the system starts by determining relationships between corresponding filter fields in a pair of network service rules (step 1202). If all of the filter fields are disjoint, the pair of the rules does not conflict (step 1204). Otherwise, if at least one of the filter field relationships is not disjoint, the pair of network service rules conflicts. At this point, the system determines the conflict relationship between the conflicting network service rules (step 1206).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for resolving conflicts between rules for network services, comprising:
receiving a set of network service rules for network data traffic from multiple network services, wherein network service rules from different network services can possibly conflict; and
resolving conflicts between network service rules in the set of network service rules by,
identifying conflicts between pairs of network service rules in the set of network service rules,
determining a priority relationship between each pair of conflicting network service rules, and
assigning priorities to network service rules in the set of network service rules in a manner consistent with the determined priority relationships, thereby allowing conflicts between network service rules to be subsequently resolved based on the assigned priorities.

2. The method of claim 1, further comprising processing an additional network service rule in an on-line manner by:
receiving the additional network service rule at run time;
identifying any conflicts that may exist between the additional network service rule and existing rules in the set of network service rules;
determining a priority relationship between the additional network service rule and any conflicting network service rules that may exist;
assigning a priority to the additional network service rule; and
reassigning priorities, if necessary, to existing network service rules in the set of network service rules.

3. The method of claim 1, wherein assigning the priorities to the network service rules involves:
generating a graph by,
creating a vertex for each network service rule in the set of network service rules,
inserting a directed edge into the graph between vertices associated with each pair of conflicting network service rules, wherein the directed edge points from a vertex associated with a lower priority network service rule to a vertex associated with a higher priority network service rule in accordance the determined priority relationship between the pair of conflicting network service rules; and
performing a topological sort on the graph; and
assigning priorities to network service rules by,
traversing vertices of the graph in sorted order, and
assigning priorities to network service rules associated with the vertices in a manner consistent with the determined priority relationships between pairs of conflicting network service rules.

4. The method of claim 3, wherein assigning priorities to network service rules involves:
assigning a priority of one to a network service rule, if the network service rule is associated with a vertex that has no directed edges pointing to other vertices; and
if a network service rule is associated with a vertex that has one or more directed edges pointing to other vertices,
determining a maximum priority for network service rules associated with the other vertices, and
assigning a priority of one plus the maximum priority to the network service rule.

5. The method of claim 1, further comprising installing a set of low-level flow rules produced from the prioritized network service rules into a flow enforcement device, which applies the set of flow rules to a packet flow received from a high-speed network connection;
whereby the network service rules from the multiple network services can be simultaneously applied to packet flow, instead of being separately applied by each network service.

6. The method of claim 1, wherein determining if a given pair of network service rules conflicts involves:
determining relationships between corresponding filter-fields in the given pair of network service rules;
if all of the filter-fields are disjoint, determining that the given pair of network service rules does not conflict; and
if at least one of the filter-field relationships is not disjoint,
determining that the given pair of network service rules does conflict, and
determining a conflict relationship between the pair of conflicting network service rules by combining the filter-field relationships.

7. The method of claim 6, wherein determining a priority relationship between a given pair of conflicting network service rules involves considering a priority policy as well as the conflict relationship between the pair of conflicting network service rules.

8. The method of claim 1, wherein each of the network service rules specifies:
a filter that defines a class of packets in the packet flow; and
an action that defines an operation to be applied to the class of packets.

9. The method of claim 8, wherein an operation defined by a network service rule can include, but is not limited to:
dropping a packet;
gathering statistical information about the packet;
controlling timer functions associated with the packet;
modifying the packet; and
passing the packet on.

10. The method of claim 1, wherein the multiple network services can include, but is not limited to:
a firewall service;
a service level agreement monitoring service;
a load balancing service;
a transport matching service;
a failover service; and
a high availability service.

11. A computer-readable storage medium storing instructions that when executed by a computer cause the computer to perform a method for resolving conflicts between rules for network services, the method comprising:
receiving a set of network service rules for network data traffic from multiple network services, wherein network service rules from different network services can possibly conflict; and
resolving conflicts between network service rules in the set of network service rules by,
identifying conflicts between pairs of network service rules in the set of network service rules,
determining a priority relationship between each pair of conflicting network service rules, and
assigning priorities to network service rules in the set of network service rules in a manner consistent with the determined priority relationships, thereby allowing conflicts between network service rules to be subsequently resolved based on the assigned priorities.

12. The computer-readable storage medium of claim 11, wherein the method further comprises processing an additional network service rule in an on-line manner by:
receiving the additional network service rule at run time;
identifying any conflicts that may exist between the additional network service rule and existing rules in the set of network service rules;
determining a priority relationship between the additional network service rule and any conflicting network service rules that may exist;
assigning a priority to the additional network service rule; and
reassigning priorities, if necessary, to existing network service rules in the set of network service rules.

13. The computer-readable storage medium of claim 11, wherein assigning the priorities to the network service rules involves:
generating a graph by,
creating a vertex for each network service rule in the set of network service rules,
inserting a directed edge into the graph between vertices associated with each pair of conflicting network service rules, wherein the directed edge points from a vertex associated with a lower priority network service rule to a vertex associated with a higher priority network service rule in accordance the determined priority relationship between the pair of conflicting network service rules; and
performing a topological sort on the graph; and
assigning priorities to network service rules by,
traversing vertices of the graph in sorted order, and
assigning priorities to network service rules associated with the vertices in a manner consistent with the determined priority relationships between pairs of conflicting network service rules.

14. The computer-readable storage medium of claim 13, wherein assigning priorities to network service rules involves:
assigning a priority of one to a network service rule, if the network service rule is associated with a vertex that has no directed edges pointing to other vertices; and
if a network service rule is associated with a vertex that has one or more directed edges pointing to other vertices,
determining a maximum priority for network service rules associated with the other vertices, and
assigning a priority of one plus the maximum priority to the network service rule.

15. The computer-readable storage medium of claim 11, wherein the method further comprises installing a set of low-level flow rules produced from the prioritized network service rules into a flow enforcement device, which applies the set of flow rules to a packet flow received from a high-speed network connection;
whereby the network service rules from the multiple network services can be simultaneously applied to packet flow, instead of being separately applied by each network service.

16. The computer-readable storage medium of claim 11, wherein determining if a given pair of network service rules conflicts involves:
determining relationships between corresponding filter-fields in the given pair of network service rules;
if all of the filter-fields are disjoint, determining that the given pair of network service rules does not conflict; and
if at least one of the filter-field relationships is not disjoint,
determining that the given pair of network service rules does conflict, and
determining a conflict relationship between the pair of conflicting network service rules by combining the filter-field relationships.

17. The computer-readable storage medium of claim 16, wherein determining a priority relationship between a given pair of conflicting network service rules involves considering a priority policy as well as the conflict relationship between the pair of conflicting network service rules.

18. The computer-readable storage medium of claim 11, wherein each of the network service rules specifies:
a filter that defines a class of packets in the packet flow; and
an action that defines an operation to be applied to the class of packets.

19. The computer-readable storage medium of claim 18, wherein an operation defined by a network service rule can include, but is not limited to:
dropping a packet;
gathering statistical information about the packet;
controlling timer functions associated with the packet;
modifying the packet; and
passing the packet on.

20. The computer-readable storage medium of claim 11, wherein the multiple network services can include, but is not limited to:
a firewall service;
a service level agreement monitoring service;
a load balancing service;
a transport matching service;
a failover service; and
a high availability service.

21. An apparatus that resolves conflicts between rules for network services, comprising:
an input configured to receive a set of network service rules for network data traffic from multiple network services, wherein network service rules from different network services can possibly conflict; and
a resolving mechanism that resolves conflicts between network service rules in the set of network service rules, wherein the resolving mechanism is configured to,
identify conflicts between pairs of network service rules in the set of network service rules,
determine a priority relationship between each pair of conflicting network service rules, and to
assign priorities to network service rules in the set of network service rules in a manner consistent with the determined priority relationships, thereby allowing conflicts between network service rules to be subsequently resolved based on the assigned priorities.

22. The apparatus claim 21, further comprising an on-line processing mechanism configured to:
receive an additional network service rule at run time;
identify any conflicts that may exist between the additional network service rule and existing rules in the set of network service rules;
determine a priority relationship between the additional network service rule and any conflicting network service rules that may exist;
assign a priority to the additional network service rule; and to reassign priorities, if necessary, to existing network service rules in the set of network service rules.

23. The apparatus of claim 21, wherein while assigning the priorities to the network service rules, the resolving mechanism is configured to:
create a vertex in a graph for each network service rule in the set of network service rules,
insert a directed edge into the graph between vertices associated with each pair of conflicting network service rules, wherein the directed edge points from a vertex associated with a lower priority network service rule to a vertex associated with a higher priority network service rule in accordance the determined priority relationship between the pair of conflicting network service rules;
perform a topological sort on the graph;
traverse vertices of the graph in sorted order, and to
assign priorities to network service rules associated with the vertices in a manner consistent with the determined priority relationships between pairs of conflicting network service rules.

24. The apparatus of claim 23, wherein while assigning priorities to network service rules, the resolving mechanism is configured to:
assign a priority of one to a network service rule, if the network service rule is associated with a vertex that has no directed edges pointing to other vertices; and
if a network service rule is associated with a vertex that has one or more directed edges pointing to other vertices, to
determine a maximum priority for network service rules associated with the other vertices, and to
assign a priority of one plus the maximum priority to the network service rule.

25. The apparatus of claim 21, further comprising a flow enforcement mechanism configured to install a set of low-level flow rules produced from the prioritized network service rules into a flow enforcement device, which applies the set of flow rules to a packet flow received from a high-speed network connection;
whereby the network service rules from the multiple network services can be simultaneously applied to packet flow, instead of being separately applied by each network service.

26. The apparatus of claim 21, wherein while determining if a given pair of network service rules conflicts, the resolving mechanism is configured to:
determine relationships between corresponding filter-fields in the given pair of network service rules;
if all of the filter-fields are disjoint, to determine that the given pair of network service rules does not conflict; and
if at least one of the filter-field relationships is not disjoint, to
determine that the given pair of network service rules does conflict, and to
determine a conflict relationship between the pair of conflicting network service rules by combining the filter-field relationships.

27. The apparatus of claim 26, wherein while determining a priority relationship between a given pair of conflicting network service rules, the resolving mechanism is configured to consider a priority policy as well as the conflict relationship between the pair of conflicting network service rules.

28. The apparatus of claim 21, wherein each of the network service rules specifies:
a filter that defines a class of packets in the packet flow; and
an action that defines an operation to be applied to the class of packets.

29. The apparatus of claim 28, wherein an operation defined by a network service rule can include, but is not limited to:
dropping a packet;
gathering statistical information about the packet;
controlling timer functions associated with the packet;
modifying the packet; and
passing the packet on.

30. The apparatus of claim 21, wherein the multiple network services can include, but is not limited to:
a firewall service;
a service level agreement monitoring service;
a load balancing service;
a transport matching service;
a failover service; and
a high availability service.
